(19) United States
(12) Patent Application Publication
(10) Pub. No.: US 2026/0066254 A1
(43) Pub. Date: Mar. 5, 2026

(54) ANALYTICAL INSTRUMENT

(71) Applicant: Micromass UK Limited, Wilmslow (GB)

(72) Inventors: Christopher Wheeldon, Glossop (GB); Nicholas Smith, Chester (GB); Kevin R. Howes, Macclesfield (GB); Ian David Trivett, Cheadle (GB); Sornanathan Meyyappan, Framingham, MA (US); Kevin Giles, Marple (GB)

(21) Appl. No.: 19/292,541

(22) Filed: Aug. 6, 2025

Related U.S. Application Data
(60) Provisional application No. 63/691,116, filed on Sep. 5, 2024.

(30) Foreign Application Priority Data
Sep. 12, 2024 (GB) 2413415.7

(51) Int. Cl. H01J 49/16

(52) U.S. Cl. CPC H01J 49/165

(57) ABSTRACT

An analytical instrument is disclosed that comprises an ion source having a sprayer that generates a spray within an enclosure. A gas flow system causes a flow of gas through the enclosure, filters sample from the flow of gas, and senses a flow rate of the flow of gas. A controller controls the gas flow system and/or the sprayer based on the sensed flow rate.

### CROSS-REFERENCE TO RELATED APPLICATION

This application claims priority from and the benefit of U.S. Provisional Patent Application No. 63/691,116 filed on Sep. 5, 2024, and United Kingdom Patent Application No. 2413415.7 filed on Sep. 12, 2024, the entire contents of which are incorporated herein by reference.

### FIELD

The present disclosure relates to analytical instruments and ion sources, and in particular to electrospray ionisation (ESI) for mass and/or ion mobility spectrometry.

### BACKGROUND

A mass spectrometer is an analytical instrument that typically comprises an ion source for generating ions from an analytical sample, and a mass analyser for analysing the ions, or ions derived therefrom, to determine their mass to charge ratio.

In charge detection mass spectrometry (CDMS), the charge and mass to charge ratio of an ion are detected and used to determine its mass. CDMS is a useful technique that enables, for example, the characterisation of large, highly-charged and heterogeneous analytes, such as whole virus capsids, that are of increasing importance in biotherapeutics.

To effectively ionise such analytes, an electrospray ionisation (ESI) ion source may be used. Electrospray ionisation (ESI) is an ionisation technique where ions are generated or released from charged droplets generated via an electrospray process. Electrospraying can be carried out by liquid forming an interface with air at the tip of an emitter and electrostatic stress generated by electrification of the liquid via an applied voltage causing charged droplets to be emitted from the liquid interface. This process typically occurs in an atmospheric pressure chamber that contains an ion inlet aperture to the spectrometer.

### SUMMARY

An aspect comprises an analytical instrument comprising:
an ion source comprising:
   an enclosure; and
   a sprayer configured to generate a spray comprising sample within the enclosure;
a gas flow system configured to cause a flow of gas through the enclosure;
wherein the gas flow system comprises at least one filter configured to filter sample from the flow of gas, and a flow sensor configured to sense a flow rate of the flow of gas; and
a controller configured to control the gas flow system and/or the sprayer based on a flow rate sensed by the flow sensor.

Embodiments relate to an analytical instrument, such as a mass spectrometer and/or ion mobility spectrometer, e.g. charge detection mass spectrometer. The instrument comprises an ion source, e.g. electrospray ionisation (ESI) ion source, that generates a spray, e.g. of charged droplets, comprising sample within an enclosure. The instrument further comprises a gas flow system that causes a flow of gas through the sprayer enclosure, and at least one filter that filters sample from the flow of gas. The gas flow system may comprise a fan/blower configured to cause the flow of gas.

As will be discussed in more detail below, providing a flow of gas through the sprayer enclosure, and filtering any sample from the flow of gas, can reduce the risk of sprayed sample unintentionally escaping the sprayer enclosure and, e.g. into the ambient environment. This may be useful for any type of sample being analysed, but may be particularly advantageous in the case of a biohazard sample, e.g. comprising virus, where biocontainment precautions may be required.

The gas flow system further comprises a flow sensor configured to sense a flow rate of the flow of gas. A controller is configured to control the gas flow system and/or the sprayer based on a flow rate sensed by the flow sensor. As will also be discussed in more detail below, actively monitoring the gas flow rate and controlling the system based on the monitoring can further reduce the risk of unintentional sample escape and exposure.

In embodiments, the ion source is configured to ionise a sample by generating a spray comprising the sample. The sprayer may comprise a capillary through which liquid comprising sample may pass, and a voltage source/supply configured to apply a voltage to the capillary and/or sample. The voltage may cause sample to be electrosprayed from an outlet/tip of the capillary. The spray may be a spray of charged droplets. The ion source may be an electrospray ionisation (ESI) ion source. One or more elements of the sprayer, such as the capillary and/or emitter tip, may be replaceable, e.g. user-replaceable.

The instrument may comprise an analyser configured to analyse ions generated by the ion source, e.g. to determine their mass, charge, mass to charge ratio, ion mobility, and/or other physico-chemical property. The analyser may be a mass analyser and/or ion mobility analyser. Correspondingly, the analytical instrument may be a mass spectrometer and/or ion mobility spectrometer. The analyser may be a charge detection mass analyser. The analytical instrument may be a charge detection mass spectrometer.

The enclosure may be a chamber, e.g. an atmospheric pressure chamber, that contains an ion inlet aperture through which ions generated by the ion source pass to be analysed by the analyser.

The enclosure may comprise a gas inlet and a gas outlet. The flow of gas caused by the gas flow system may pass into the enclosure through the gas inlet, through the enclosure, and out of the enclosure through the gas outlet. The flow of gas may pass through the at least one filter. The flow of gas may pass through the fan/blower.

The flow of gas may comprise ambient air, such as filtered ambient air.

The flow of gas through the enclosure may be such that the generation of the spray by the sprayer is not significantly affected, e.g. the sprayer may be able to generate a spray with and without the flow of gas through the enclosure being present. The flow of gas through the enclosure may be such that the passage of ions through the ion inlet aperture for analysis is not significantly affected, e.g. ions may be able to pass through the ion inlet aperture with and without the flow of gas through the enclosure being present. The flow of gas through the enclosure may be such that sprayed sample, e.g. any sprayed sample, that does not pass through the ion inlet aperture for analysis is carried out of the enclosure by the flow of gas, e.g. through the gas outlet.

The fan/blower may be located downstream of the enclosure, e.g. downstream of the gas outlet. The fan/blower may operate as an extractor that extracts gas from the enclosure, e.g. through the gas outlet.

The at least one filter may be located downstream of the ion source enclosure, e.g. downstream of the gas outlet. The at least one filter may be configured to filter sample from gas extracted from the ion source enclosure, e.g. via the gas outlet. At least one filter may be located upstream and/or downstream of the fan/blower. At least one filter may be located between the enclosure and the fan/blower, e.g. between the gas outlet and the fan/blower. At least one filter may be a HEPA filter. At least one filter may be replaceable, e.g. user-replaceable. The at least one filter may be only one filter, or two or more filters.

The gas flow system comprises a flow sensor configured to sense a flow rate of the flow of gas. The flow of gas may pass through the flow sensor. The flow sensor may be located downstream of the enclosure, e.g. downstream of the gas outlet. The flow sensor may be configured to sense a flow rate of gas extracted from the enclosure, e.g. via the gas outlet. The flow sensor may be located upstream or downstream of the fan/blower. The flow sensor may be located upstream or downstream of at least one filter. The flow sensor may be located between the enclosure and the at least one filter, e.g. between the gas outlet and the at least one filter.

The instrument/system comprises a controller. The controller may be configured to actively monitor the flow rate sensed by the flow sensor. The controller may be configured to control the gas flow system based on a flow rate sensed by the flow sensor. The controller may be configured to control the fan/blower based on a flow rate sensed by the flow sensor. The controller may control a speed of the fan/blower to maintain, or try to maintain, a predetermined gas flow rate that may be sensed by the flow sensor. The controller may be configured to control the fan/blower based on whether or not the sprayer is generating a spray. The controller may control the speed of the fan/blower/gas flow rate to be higher when the sprayer is not generating a spray than when the sprayer is generating a spray.

The controller may be configured to control the sprayer based on a flow rate sensed by the flow sensor. The controller may deactivate the sprayer in response to determining that a gas flow rate that may be sensed by the flow sensor is different to expected. The controller may deactivate the sprayer by causing the voltage source to reduce or remove the applied voltage. The controller may provide an alert, e.g. a user alert, in response to determining that a gas flow rate that may be sensed by the flow sensor is different to expected, e.g. a visual and/or audible alert. The controller may determine that a gas flow rate that may be sensed by the flow sensor is different to expected when the flow rate is greater than a predetermined threshold and/or less than a predetermined threshold, e.g. outside of a predetermined range. The controller may determine that a gas flow rate that may be sensed by the flow sensor is different to expected when the flow rate indicates that at least one filter is, or is likely to be, blocked and/or not fitted and/or not fitted correctly.

The controller may use a flow rate sensed by the flow sensor to determine when a predetermined amount, e.g. volume, of gas has flowed through the enclosure, e.g. since the sprayer last finished generating a spray, i.e. since the sprayer last deactivated. The controller may, when it is determined that the predetermined amount, e.g. volume, of gas has flowed through the enclosure, provide an indication, e.g. user indication, that that is the case. The controller may not provide the indication until it is determined that the predetermined amount, e.g. volume, of gas has flowed through the enclosure.

The predetermined amount, e.g. volume, of gas may be an amount of gas sufficient to carry any/all residual sprayed sample out of the enclosure. The indication may be an indication that it is determined to be safe to open the enclosure, e.g. in order to replace the sprayer or element thereof, such as a capillary or emitter tip. The controller may, until it is determined that the predetermined amount of gas has flowed through the enclosure, provide an indication, e.g. user indication, that it is not yet safe to open the enclosure. An indication may comprise a visual and/or audible indication, and/or may comprise allowing and/or preventing opening of the enclosure.

The gas flow system may comprise a manifold configured to introduce the flow of gas into the enclosure. The manifold may be configured to introduce a substantially laminar flow of gas into the enclosure, i.e. substantially without turbulence. The manifold may comprise only a single gas inlet, and multiple gas outlets. The flow of gas caused by the gas flow system may pass into the enclosure through the multiple gas outlets of the manifold. The manifold may thereby split the flow of gas into multiple flow paths. The manifold may comprise a branching structure configured to split the flow of gas into the multiple flow paths.

The branching structure may have a hierarchical tree structure. The branching structure may split a flow of gas, that may pass into the manifold through the single gas inlet of the manifold, into multiple different flow paths, that may each pass into the enclosure through a respective gas outlet of the multiple gas outlets of the manifold, by at least splitting a parent flow path into plural “child” flow paths, and splitting each of the plural child flow paths into plural “grandchild” flow paths. The branching structure may further split each of the plural grandchild flow paths into plural “great grandchild” flow paths, etc.

Another aspect comprises an ion source comprising:
an enclosure; and
a sprayer configured to generate a spray comprising sample within the enclosure; and
a manifold configured to introduce a flow of gas into the enclosure as multiple different flow paths, wherein the manifold comprises a branching structure configured to split a flow of gas into the multiple different flow paths;
wherein the branching structure is configured to split a flow of gas into the multiple different flow paths by at least splitting a parent flow path into plural child flow paths, and splitting each of the plural child flow paths into plural grandchild flow paths.

These aspects and embodiments can, and in embodiments do, comprise one or more, e.g. all, optional features of other aspects and embodiments described herein, as appropriate. For example, the ion source may be an electrospray ionisation (ESI) ion source.

The branching structure may split a “parent” flow path into plural, e.g. two, “child” flow paths, split a or each “child” flow path into plural, e.g. two, “grandchild” flow paths, e.g. and so on. The manifold may thereby split the flow of gas into a power-of-two number of flow paths, such as 4, 8 or 16, and may comprise that number of gas outlets. However, other branching configurations are possible. For example, a flow path may split into three or more flow paths and/or different flow paths may split into different numbers of flow paths.

The manifold may be substantially toroidal. The manifold may introduce the flow of gas into the enclosure as multiple flow paths that pass around the sprayer/spray. A or each output flow path from a gas outlet of the manifold may be substantially parallel to, or angled with respect to, a longitudinal axis of the sprayer/capillary, e.g. and so substantially parallel to, or angled with respect to, a direction in which sample is sprayed by the sprayer.

The multiple gas outlets of the manifold, and corresponding flow paths, may be arranged coaxially with the sprayer/capillary, e.g. such that a radial distance between each gas outlet of the manifold and the longitudinal axis of the sprayer/capillary is substantially the same. The multiple gas outlets of the manifold, and corresponding flow paths, may be spaced evenly around the sprayer/capillary, e.g. such that a circumferential distance between each adjacent pair of gas outlets of the manifold is substantially the same.

Another aspect comprises a method of operating an analytical instrument; the method comprising:
generating ions by generating a spray comprising sample within an enclosure;
causing a flow of gas through the enclosure;
filtering sample from the flow of gas;
sensing a flow rate of the flow of gas; and
controlling the flow of gas and/or the generating of the spray based on the sensed flow rate.

These aspects and embodiments can, and in embodiments do, comprise one or more, e.g. all, optional features of other aspects and embodiments described herein, as appropriate.

For example, causing a flow of gas through the enclosure may comprise causing the flow of gas through the enclosure without significantly affecting the generating of the spray. The method may comprise causing generated ions to pass through an ion inlet aperture, and analysing ions that have passed through the ion inlet aperture. Causing a flow of gas through the enclosure may comprise venting (any) sprayed sample from the enclosure that has not passed through the ion inlet aperture for analysis.

Causing a flow of gas through the enclosure may comprise extracting gas from the enclosure. Filtering sample from the flow of gas may comprise filtering sample from gas extracted from the enclosure.

The method comprises sensing a flow rate of the flow of gas. The method comprises controlling the flow of gas and/or the generating of the spray based on a sensed flow rate of the flow of gas.

The controlling may comprise controlling the flow of gas so as to maintain, or try to maintain, the sensed flow rate at a predetermined gas flow rate. The flow of gas may be controlled based on whether or not the sprayer is generating a spray.

The controlling may comprise determining whether a sensed flow rate of the flow of gas is different to an expected flow rate; and when it is determined that a sensed flow rate of the flow of gas is different to an expected flow rate: ceasing generating the spray.

The method may comprise ceasing generating the spray; determining, using a sensed flow rate of the flow of gas, when a predetermined amount of gas has flowed through the enclosure; and indicating when the predetermined amount of gas has flowed through the enclosure since ceasing generating the spray.

The method may comprise introducing the flow of gas into the enclosure through multiple outlets of a manifold that may be toroidal. The method may comprise introducing the flow of gas into the enclosure through the multiple outlets of the manifold substantially without generating turbulence. The method may comprise splitting the flow of gas into multiple different flow paths using a branching structure of the manifold.

Generating ions may comprise generating the ions by electrospray ionisation (ESI).

The method may comprise analysing the generated ions, e.g. by mass analysis and/or ion mobility analysis, such as charge detection mass analysis. The analytical instrument may be a mass spectrometer and/or ion mobility spectrometer, such as a charge detection mass spectrometer. The method may be a method of mass spectrometry and/or ion mobility spectrometry, such as a method of charge detection mass spectrometry (CDMS).

Another aspect comprises an analytical instrument comprising:
an ion source comprising:
   an enclosure; and
   a sprayer configured to generate a spray comprising sample within the enclosure; and
a gas flow system configured to cause a flow of gas through the enclosure;
wherein the gas flow system comprises at least one filter configured to filter sample from the flow of gas.

Another aspect comprises a method of operating an analytical instrument; the method comprising:
generating ions by generating a spray comprising sample within an enclosure;
causing a flow of gas through the enclosure; and
filtering sample from the flow of gas.

Another aspect comprises an ion source comprising:
an enclosure; and
a sprayer configured to generate a spray comprising sample within the enclosure; and
a manifold configured to introduce a flow of gas into the enclosure, wherein the manifold comprises a branching structure configured to split a flow of gas into multiple different flow paths.

These aspect and embodiments can, and in embodiments do, comprise one or more, e.g. all, optional features of other aspect and embodiments described herein, as appropriate.

### BRIEF DESCRIPTION OF THE DRAWINGS

Various embodiments will now be described, by way of example only, and with reference to the accompanying drawings in which:

FIG. 1 shows an analytical instrument in accordance with embodiments;

FIG. 2A shows a charge detection mass analyser in accordance with embodiments;

FIG. 2B shows an electrospray ionisation (ESI) ion source in accordance with embodiments;

FIG. 3 shows an analytical instrument having a gas flow system in accordance with embodiments;

FIG. 4 shows an ion source having a gas flow system in accordance with embodiments;

FIG. 5 shows a gas manifold of a gas flow system in accordance with embodiments; and

FIG. 6 shows results of computational fluid dynamics (CFD) modelling of the gas manifold of FIG. 5 in accordance with embodiments.

### DETAILED DESCRIPTION

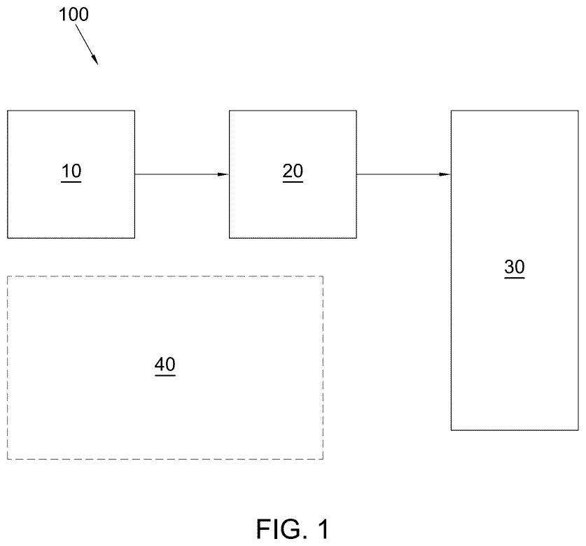

FIG. 1 shows schematically an analytical instrument 100 in accordance with various embodiments. As shown in FIG. 1, the analytical instrument 100 comprises an ion source 10, one or more functional components 20 that are arranged downstream from the ion source 10, and an analyser 30 that is arranged downstream from the ion source 10 and from the one or more functional components 20.

It should be noted that FIG. 1 is merely schematic, and that the analytical instrument 100 may, and in various embodiments does, include other components, devices and functional elements to those shown in FIG. 1.

The ion source 10 is configured to generate ions by ionising an analyte. The analytical instrument 100 may optionally comprise a chromatography or other separation device (not shown in FIG. 1) upstream of and coupled to the ion source 10.

The analyser 30 is configured to analyse ions so as to determine (measure) one or more of their physical or chemical properties, such as their mass, charge, mass to charge ratio, time of flight, ion mobility drift time and/or collision cross section (CCS), differential ion mobility, etc. The analyser 30 may comprise a mass analyser that may be configured to determine the mass to charge ratio or time of flight of ions and/or an ion mobility analyser that may be configured to determine the ion mobility drift time or collision cross section (CCS) or differential ion mobility of ions. The mass analyser may, for example, comprise a quadrupole mass analyser, a Time of Flight mass analyser, a linear ion trap mass analyser, or a charge detection mass analyser.

As shown in FIG. 1, the analytical instrument 100 comprises a control system 40, that may be configured to control the operation of the analytical instrument 100, for example in the manner of the various embodiments described herein. The control system 40 may comprise suitable control circuitry that is configured to cause the instrument to operate in the manner of the various embodiments described herein. In various embodiments, the control system 40 may comprise a suitable computing device, a microprocessor system, a programmable FPGA (field programmable gate array), and the like. In various embodiments, the control system comprises storage, e.g. a memory, for storing information and instructions for performing methods described herein.

As illustrated by FIG. 1, the analytical instrument 100 is configured such that ions can be provided by the ion source 10 to the analyser 30 via the one or more functional components 20. The one or more functional components 20 may comprise any suitable such components, devices and functional elements of an analytical instrument, e.g. mass and/or ion mobility spectrometer.

In various embodiments, the ion source 10 operates at a higher pressure than the analyser 30. For example, the analyser 30 operates at high vacuum and the ion source 10 operates at low vacuum or at substantially atmospheric pressure. The one or more functional components 20 may comprise one or more, e.g. a series of, vacuum stages for reducing and maintaining the desired pressures.

In various embodiments, the one or more functional components 20 comprise one or more ion guides and/or one or more ion traps. In various embodiments, the one or more functional components 20 comprise a mass filter, which may be configured to filter ions according to their mass to charge ratio. In various embodiments, the one or more functional components 20 comprise an activation, collision, fragmentation or reaction device configured to activate, fragment or react ions. In various embodiments, the one or more functional components 20 comprise an ion mobility separator configured to separate ions according to their ion mobility.

Other functional components 20 would be possible.

In various embodiments, the analytical instrument 100 is a charge detection mass spectrometer and the analyser 30 is a charge detection mass analyser configured to determine the charge and mass to charge ratio of ions.

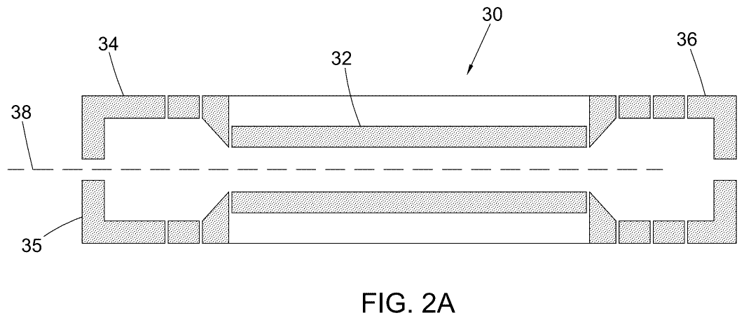

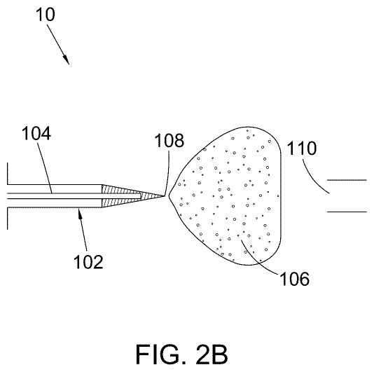

FIG. 2A shows a schematic of a charge detection mass analyser 30 in accordance with embodiments. As shown in FIG. 2A, the analyser 30 comprises a charge detector 32 arranged between a first reflectron or ion mirror 34 and a second reflectron or ion mirror 36. In use, ions 38 to be analysed pass through an end cap 35 of the first reflectron 34, and then oscillate between the reflectrons 34, 36, and therefore through the charge detector 32, at a frequency that is related to mass to charge ratio. Each time an ion passes through charge detector 32, it induces an electrical charge on the detector 32. The mass to charge ratio of an ion is determined from the frequency at which charge is induced on the charge detector 32, and the charge of the ion is determined from the amplitude of the charge that is induced on the charge detector 32. The mass of the ion may be determined by multiplying the detected mass to charge ratio by the detected charge of the ion. Multiple different ions may be analysed simultaneously by deconvolving respective signals induced on the charge detector 32 by the different ions.

Charge detection mass spectrometry (CDMS) is a useful technique that enables, for example, the characterisation of large, highly-charged and heterogeneous analytes, such as whole virus capsids, that are of increasing importance in biotherapeutics. To effectively ionise such analytes, an electrospray ionisation (ESI) ion source may be used.

FIG. 2B shows schematically an electrospray ionisation (ESI) ion source 10 in accordance with embodiments. As shown in FIG. 2B, the ion source 10 comprises an emitter 102 comprising an internal capillary 104 that, in use, will emit charged droplets 106 of a sample via an electrospray process when the sample is provided to an outlet orifice 108 of the capillary 104 and the sample is electrified.

The outlet orifice 108 is located at an outlet end of the emitter 102 and may be sized to allow the emitter 102 to be suitable for use in a nano electrospray ionisation (NanoESI) process. For example, a diameter of the outlet orifice 108 at the downstream end may be less than 100 μm, less than 50 μm, or less than 25 μm, such as between 0.1 μm and 20 μm.

In use, a meniscus of the sample can form extending out of the capillary 104 at the outlet orifice 108, e.g. in the form of a Taylor cone, and electrostatic stress within the sample resulting from its electrification can cause charged droplets 106 to be emitted from the meniscus.

Successively smaller droplets may then be created from the charged droplets, e.g. by evaporation of the sample causing the droplets to decrease in size and burst into smaller droplets as a result of increasing electrostatic forces within the charged droplets 106 as they decrease in size. This process can lead to gaseous phase ions emitted from the droplets being obtained for use, e.g. by entering an inlet 110 of the analytical instrument for analysis.

Any suitable voltage for electrospraying a particular sample may be used. In embodiments, a voltage greater than 100 V is supplied to the sample to electrospray it. For example, the voltage may be between 100 V and 10 kV, such as between 200 V and 4.5 kV, such as about 3 kV.

The electrospraying process occurs in an ESI sprayer chamber (not shown in FIG. 2B) that contains the ion inlet aperture 110 to the spectrometer. FIG. 2B shows a tubular ion inlet aperture 110, but other inlet aperture geometries are possible, such as conical.

Typically, an ESI sprayer chamber may be maintained at a pressure above ambient pressure, e.g. so as to as to avoid undesired contaminants entering the sprayer chamber and affecting the sample analysis. The inventors have recognised, however, that such arrangements can result in an increased risk of sample escaping from the sprayer chamber and into the ambient environment. This may be an unacceptable risk in the case of a biohazard sample, e.g. virus.

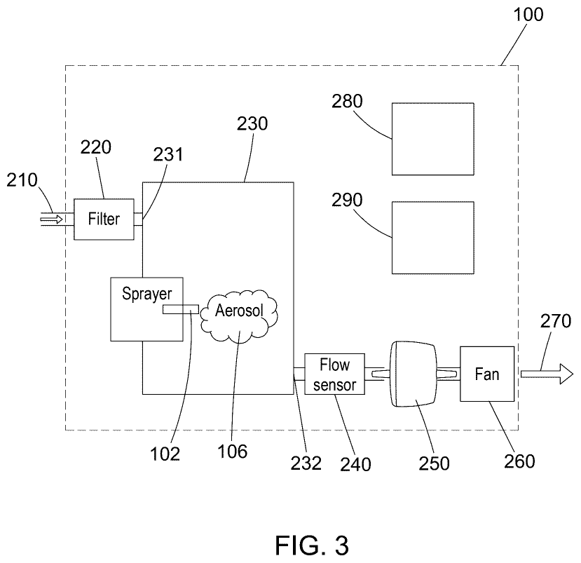

FIG. 3 shows schematically a charge detection mass spectrometer 100 according to embodiments. It will again be appreciated that FIG. 3 is merely schematic, and that the spectrometer 100 may, and in various embodiments does, include other components, devices and functional elements to those shown in FIG. 3, such as charge detection mass analyser 30.

As illustrated in FIG. 3, the spectrometer 100 comprises an ESI ion source 10 that includes an ESI emitter 102 that can generate an aerosol of charged droplets 106 within ESI sprayer chamber 230. The sprayer chamber 230 contains ion inlet aperture 110 (not shown in FIG. 3), through which ions generated by ESI emitter 102 pass for analysis.

The spectrometer 100 further comprises a gas extraction system that includes various components connected by conduits. As illustrated in FIG. 3, the sprayer chamber 230 comprises a gas inlet 231 and a gas outlet 232. A fan 260, e.g. radial blower, located downstream of the gas outlet 232 is configured to extract gas from the sprayer chamber 230 through the gas outlet 232, and thereby cause gas to enter the sprayer chamber 230 through gas inlet 231 and pass through the sprayer chamber 230 to the gas outlet 232. The sprayer chamber 230 may thereby be maintained at a pressure below ambient pressure.

In the present embodiment, the gas that enters the sprayer chamber 230 through gas inlet 231 is filtered ambient air. As shown in FIG. 3, air from the ambient environment, e.g. lab, is received by air intake 210 and filtered by upstream filter 220 before entering sprayer chamber 230 through gas inlet 231. Other input gases, such as nitrogen, would be possible.

The flow of gas thereby produced through the sprayer chamber 230 is such that any sprayed sample that does not enter the ion inlet aperture 110 for analysis will be extracted from the sprayer chamber 230 through gas outlet 232.

As illustrated in FIG. 3, the gas extracted from the sprayer chamber 230 through gas outlet 232 passes through a downstream filter 250 that is configured to filter out any/all sprayed sample carried in the extracted gas. In the present embodiment, the downstream filter 250 is a HEPA filter, but other types of filter may be possible. The filtered gas then exhausts through gas exhaust 270. In the present embodiment, the filtered gas exhausts through gas exhaust 270 into the ambient environment, e.g. lab, or into a gas management system. Other arrangements may be possible.

Actively extracting and filtering gas from the sprayer chamber 230 in this manner can reduce the risk of aerosolised sample unintentionally escaping into the ambient environment. This may be useful for any type of sample being analysed, but may be particularly advantageous in the case of a biohazard sample, e.g. comprising virus. For example, embodiments can facilitate compliance with biosafety level (BSL) biocontainment precautions.

The fan 260 could run at a constant fan speed. However, the inventors have found that with a constant fan speed, the actual rate of gas extraction from the sprayer chamber 230 may vary, e.g. depending on the state of the filters, etc., which can result in incomplete extraction.

In the present embodiment, therefore, the speed of fan 260 is variable and is controlled by controller 280. As shown in FIG. 3, a flow sensor 240 is provided downstream of the gas outlet 232 and is used to measure the actual rate of gas extraction from the sprayer chamber 230. Controller 40, 280 controls the fan speed of the fan 260 based on the gas extraction rate information from the flow sensor 240, e.g. so as to maintain a desired extraction rate. Actively monitoring and controlling extraction rate through the sprayer chamber 230 in this manner can further reduce the risk of unintentional sample escape and exposure.

In the present embodiment, the controller 280 also monitors the extraction rate measured by the flow sensor 240 in order to monitor performance and detect failure of the gas extraction system. If the extraction rate measured by the flow sensor 240 is outside of an expected range, e.g. based on the current fan speed, then it may be determined that a failure has occurred. In response to determining that a failure of the gas extraction system has occurred, the controller 280 deactivates the sprayer 102, e.g. by removing the voltage applied to the sprayer 102. The controller 280 may furthermore cause user alert device 290 to provide an alert, e.g. a visual and/or audible alert, to indicate that a failure has occurred. This can further reduce the risk of unintentional sample escape and exposure.

For example, in the present embodiment, upstream filter 220 and/or downstream filter 250 are user replaceable filters. If the extraction rate measured by the flow sensor 240 is less than an expected extraction rate, e.g. based on the current fan speed, then it may be assumed that one or both of the filters 220, 250 are blocked, e.g. and need replacing. In this case, sprayer 102 may be deactivated, and an indication that one or both of the filters 220, 250 should be replaced may be provided to a user by user alert device 290. Similarly, if the extraction rate measured by the flow sensor 240 is greater than an expected extraction rate, e.g. based on the current fan speed, then it may be assumed that one or both of the filters 220, 250 is not present or not correctly fitted. In this case, sprayer 102 may be deactivated, and an appropriate alert may be provided by user alert device 290. The controller 280 may also be able to detect failure of the fan 260, and deactivate the sprayer 102 in response to detecting failure of the fan 260.

In the present embodiment, components of the ESI sprayer 102, such as the emitter tip and the capillary, are also replaceable by opening the sprayer chamber 230. To reduce risk associated with opening the sprayer chamber 230, the controller 280 uses extraction rate information from the flow sensor 240 to determine when sufficient gas flow has occurred through the sprayer chamber 230 to vent any residual sample/spray from the sprayer chamber 230, and thus make opening the sprayer chamber 230 safe.

To do this, the controller 280 uses extraction rate information from the flow sensor 240 to keep track of a total volume of gas that has passed through the sprayer chamber 230 since the sprayer 102 was last in use. When the controller 280 determines that a sufficient volume of gas has passed through the sprayer chamber 230 since the sprayer 102 was last in use, it causes user alert device 290 to provide an appropriate indication that it is safe to open the sprayer chamber 230. The controller 280 causes user alert device 290 to provide an indication that it is not yet safe to open the sprayer chamber 230 until the controller 280 determines that the sufficient volume of gas has passed through the sprayer chamber 230. This can further reduce the risk of unintentional sample escape and exposure.

The indication provided by alert device 290 may be in the form of a red light indicating that it is not yet determined to be safe to open the sprayer chamber 230, and a green light indicating that it is determined to be safe to open the sprayer chamber 230. Additionally or alternatively, an interlock may prevent opening of the sprayer chamber 230 while it is not yet determined to be safe to open the sprayer chamber 230, and only allow the sprayer chamber 230 to be opened when it is determined to be safe to do so. Other indications would be possible.

In embodiments, the controller 280 sets a higher fan speed/extraction rate when the sprayer 102 is not generating a spray than when the sprayer 102 is generating a spray. This can reduce the time in which residual sample/spray is vented from the sprayer chamber 230, while avoiding affecting spray formation.

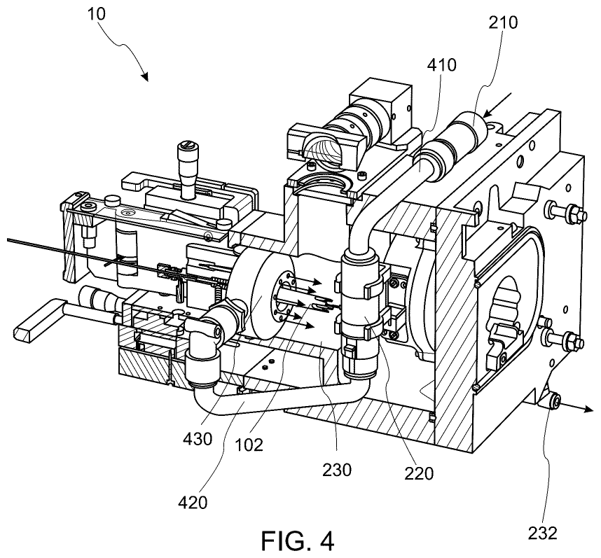

FIG. 4 shows in more detail an ESI ion source 10 according to an embodiment. As shown in FIG. 4, the ion source 10 includes an ESI sprayer 102 that is configured to generate a spray of charged droplets within sprayer chamber 230. A gas flow system includes an air intake 210 that may comprise a non-return valve. Air entering air intake 210 passes through conduit 410, and is filtered by in-line upstream filter 220. The filtered air passes through conduit 420 to gas manifold 430, which introduces the filtered air into the sprayer chamber 230. The filtered air passes through the sprayer chamber 230 and leaves the sprayer chamber 230 through outlet 232. Air leaving the sprayer chamber 230 through outlet 232, which may be carrying sprayed sample, is filtered by a downstream filter 250 (not shown in FIG. 4), e.g. as described above.

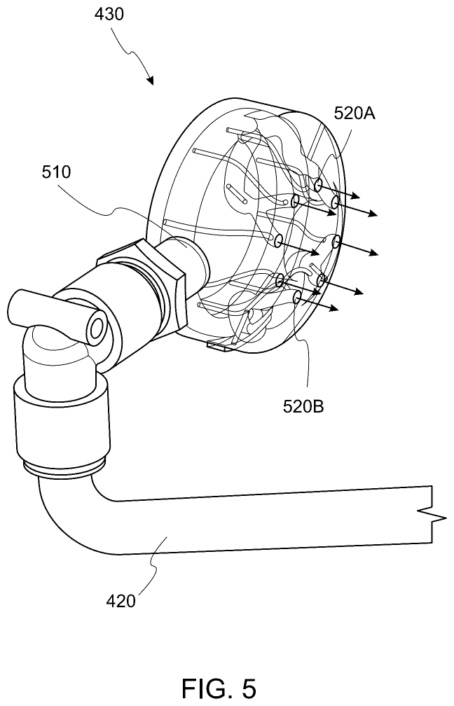

FIG. 5 shows a semi-transparent view of the gas introduction manifold 430 in more detail. The gas manifold 430 is substantially toroidal, with the ESI sprayer 102 passing through the torus “hole”. The gas manifold 430 is configured to introduce a flow of gas into the sprayer chamber 230 and around the emitter 102 and spray 106 without significantly affecting spray formation by the ESI emitter 102. As illustrated in FIG. 5, to do this, the gas manifold 430 receives filtered air from conduit 420 through a single inlet 510, splits the input air into multiple flow paths, and outputs filtered air through multiple outlets, such as outlets 520A, 520B. In the present embodiment, the gas manifold 430 splits the input gas into eight flow paths and outputs gas through eight corresponding outlets, but other numbers of flow paths/outlets would be possible.

As can be seen in FIG. 5, the gas manifold 430 contains a branching structure which splits the input flow of gas evenly into the multiple output flows, such that the flow rate of gas output by each of the multiple outlets is substantially the same.

In the present embodiment, the branching structure effectively presents a two-way tree structure in which the input flow of gas is effectively split evenly into two flow paths, then each of those flow paths is effectively split evenly into two paths, and then each of those flow paths is effectively split evenly into two paths. Other tree configurations are possible. For example, a flow path may split into three or more flow paths and/or different flow paths may split into different numbers of flow paths.

In the present embodiment, each flow path has a substantially circular cross-section. Other cross-sections, such as oval, square, etc., are possible, and different flow paths may have different cross-sections. The ratio of the cross-sectional area of a “parent” flow path to the cross-sectional area of its “child” flow path may be selected such that flows are divided evenly. Other branching tree structures may be possible.

As can best be seen in FIG. 4, each of the multiple outlets 520 has a substantially circular cross-section and causes an output flow of gas, i.e. filtered air, parallel to a longitudinal axis of the ESI emitter 102, and parallel to the direction in which sample is sprayed by the sprayer 102. Alternatively, the output flows may be angled, e.g. towards the spray and/or such that a rotating output flow of gas is generated. The outlets are spaced evenly, such that the circumferential distance between each pair of adjacent outlets is substantially the same. The outlets are arranged coaxially around the ESI emitter 102, such that each outlet is located at substantially the same radial distance from the longitudinal axis of the ESI emitter 102.

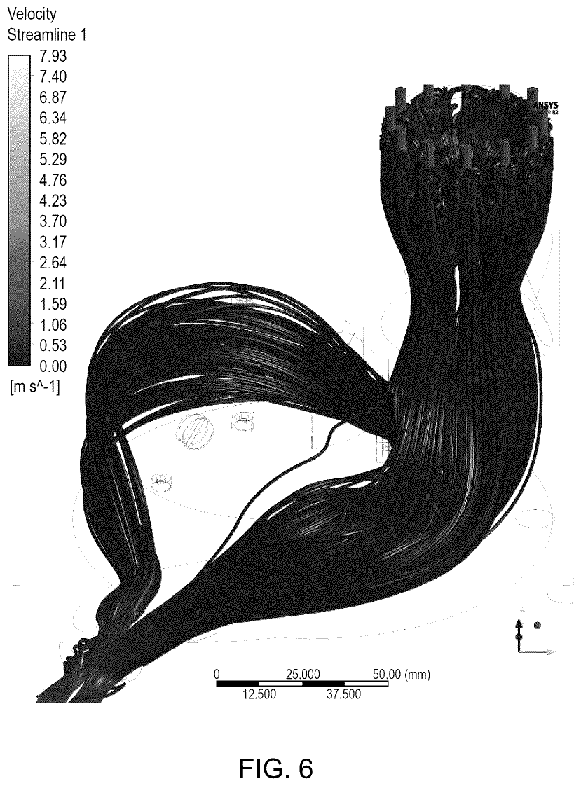

The flow of gas produced by the gas manifold 430 passes around the sprayer 102 and spray 106 without affecting spray formation, and such that any sprayed sample that does not pass through the ion inlet aperture for analysis will be carried out of the enclosure by the flow of gas. The size, shape, number, and location of the outlets, and the flow rate therethrough, etc., may selected so as to not to significantly affect spray formation by the ESI emitter 102, and to avoid pockets of still air forming in the enclosure. FIG. 6 shows the results of computational fluid dynamics (CFD) modelling of the gas manifold 430, demonstrating a substantially laminar output flow with minimal turbulence, thereby minimising effects on spray formation.

Although above described embodiments have one downstream HEPA filter 250 that is in between the sprayer chamber 230 and the fan 260, other arrangements are possible. For example, two or more filters, e.g. HEPA filters, may be provided downstream of the sprayer chamber 230. For example, two or more filters, e.g. HEPA filters, may be provided in series, e.g. in between the sprayer chamber 230 and the fan 260. Additionally or alternatively, one or more filters, e.g. HEPA filters, may be located downstream of the fan 260. For example, one or more filters, e.g. HEPA filters, may be provided in between the sprayer chamber 230 and the fan 260, and one or more filters, e.g. HEPA filters, may be provided downstream of the fan 260. A filter, e.g. HEPA filter, downstream of the fan 260 may be part of a gas management system that exhaust gas from the gas flow system exhausts into.

Furthermore, as well as providing one or more filters to filter gas exhausted from the source 10, one of more filters, e.g. HEPA filters, may be provided to filter gas exhausted from the one or more functional components 20 and/or analyser 30. For example, one or more filters, e.g. HEPA filters, may be provided upstream and/or downstream of a vacuum pump, and/or in between vacuum pumps. For example, one or more filters, e.g. HEPA filters, may be provided in between a turbopump and a backing pump.

Although embodiments have been described with particular reference to electrospray ionisation (ESI), other embodiments relate to other ionisation techniques that generate a spray of sample. Similarly, although embodiments have been described with particular reference to a charge detection mass spectrometer, other embodiments relate to other types of mass spectrometer or analytical instrument, such as an ion mobility spectrometer.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. An analytical instrument comprising:
an ion source comprising:
an enclosure; and
a sprayer configured to generate a spray comprising sample within the enclosure;
a gas flow system configured to cause a flow of gas through the enclosure;
wherein the gas flow system comprises at least one filter configured to filter sample from the flow of gas, and a flow sensor configured to sense a flow rate of the flow of gas; and
a controller configured to control the gas flow system and/or the sprayer based on a flow rate sensed by the flow sensor.

2. The analytical instrument of claim 1, wherein the gas flow system is configured to extract gas from the enclosure, and the at least one filter is configured to filter sample from gas extracted from the enclosure.

3. The analytical instrument of claim 1, wherein the gas flow system comprises a fan or blower, and the controller is configured to control the fan or blower based on a flow rate sensed by the flow sensor.

4. The analytical instrument of claim 3, wherein the controller is configured to control the fan or blower based on whether or not the sprayer is generating a spray.

5. The analytical instrument of claim 1, wherein the controller is configured to:
determine whether a flow rate sensed by the flow sensor is different to an expected flow rate; and
when it is determined that a flow rate sensed by the flow sensor is different to an expected flow rate:
deactivate the sprayer.

6. The analytical instrument of claim 1, wherein the controller is configured to:
determine, using a flow rate sensed by the flow sensor, whether a predetermined amount of gas has flowed through the enclosure since the sprayer finished generating a spray; and
indicate when it is determined that the predetermined amount of gas has flowed through the enclosure since the sprayer finished generating a spray.

7. The analytical instrument of claim 1, wherein the gas flow system comprises a manifold configured to introduce the flow of gas into the enclosure through multiple outlets.

8. The analytical instrument of claim 7, wherein the manifold comprises a branching structure configured to split a flow of gas into multiple different flow paths.

9. The analytical instrument of claim 1, wherein the ion source is an electrospray ionisation (ESI) ion source.

10. The analytical instrument of claim 1, wherein the analytical instrument is a mass spectrometer, ion mobility spectrometer or charge detection mass spectrometer.

11. An ion source comprising:
an enclosure;
a sprayer configured to generate a spray comprising sample within the enclosure; and
a manifold configured to introduce a flow of gas into the enclosure as multiple different flow paths, wherein the manifold comprises a branching structure configured to split a flow of gas into the multiple different flow paths;
wherein the branching structure is configured to split a flow of gas into the multiple different flow paths by at least splitting a parent flow path into plural child flow paths, and splitting each of the plural child flow paths into plural grandchild flow paths.

12. A method of operating an analytical instrument; the method comprising:
generating ions by generating a spray comprising sample within an enclosure;
causing a flow of gas through the enclosure;
filtering sample from the flow of gas;
sensing a flow rate of the flow of gas; and
controlling the flow of gas and/or the generating of the spray based on the sensed flow rate.

13. The method of claim 12, wherein:
causing a flow of gas through the enclosure comprises extracting gas from the enclosure; and
filtering sample from the flow of gas comprises filtering sample from gas extracted from the enclosure.

14. The method of claim 12, comprising controlling the flow of gas based on whether or not the sprayer is generating a spray.

15. The method of claim 12, comprising:
determining whether a sensed flow rate of the flow of gas is different to an expected flow rate; and
when it is determined that a sensed flow rate of the flow of gas is different to an expected flow rate:
ceasing generating the spray.

16. The method of claim 12, comprising:
ceasing generating the spray; and
indicating, based on a sensed flow rate of the flow of gas, when a predetermined amount of gas has flowed through the enclosure since ceasing generating the spray.

17. The method of claim 12, comprising introducing the flow of gas into the enclosure through multiple outlets of a manifold.

18. The method of claim 17, comprising splitting the flow of gas into multiple different flow paths using a branching structure of the manifold.

19. The method of claim 12, wherein generating ions comprises generating the ions by electrospray ionisation (ESI).

20. The method of claim 12, wherein the analytical instrument is a mass spectrometer, ion mobility spectrometer or charge detection mass spectrometer.
